(19) United States
(12) Patent Application Publication
(10) Pub. No.: US 2009/0027519 A1
(43) Pub. Date: Jan. 29, 2009

(54) NOISE REDUCTION DEVICE, NOISE REDUCTION METHOD AND VIDEO CAMERA

(76) Inventors: Katsuhiro Nishiwaki, Chita-gun (JP); Hiroshi Nagatsuma, Nagoya (JP); Yasuo Masui, Nishikamo-gun (JP); Tadamasa Nakamura, Nagoya (JP)

Correspondence Address: OSTROLENK FABER GERB & SOFFEN, 1180 AVENUE OF THE AMERICAS, NEW YORK, NY, 100368403, US

(21) Appl. No.: 12/178,131

(22) Filed: Jul. 23, 2008

(30) Foreign Application Priority Data
Jul. 23, 2007 (JP) 2007-190851

(51) Int. Cl. H04N 5/217

(52) U.S. Cl. 348/241; 348/E05.078

(57) ABSTRACT

A noise reduction device to reduce noise of a video image including multiple input frame images is provided. The noise reduction device includes: a motion detector that detects a dynamic region and a static region other than the dynamic region within the video image; and a temporal smoothing processing unit that generates temporally-smoothed frame images by applying a temporal smoothing process to the multiple input frame images, the temporal smoothing process keeping number of color component contained in each pixel, the each pixel constituting an individual frame image of the multiple input frame images and containing only a part of a plurality of color components. A temporal smoothing level for a static region pixel belonging to the static region is set to be higher than the temporal smoothing level for a dynamic region pixel belonging to the dynamic region.

### CROSS-REFERENCE TO RELATED APPLICATIONS

The present application claims the priority based on Japanese Patent Application No. 2007-190851 filed on Jul. 23, 2007, the disclosure of which is hereby incorporated herein by reference in its entirety.

### BACKGROUND OF THE INVENTION

1. Field of the Invention

This invention relates to a technique to reduce noise of a color video image.

2. Description of the Related Art

Noise of video image is conventionally reduced using a recursive filter that applies an accumulative addition process to image data constituting video image. Such a recursive filter performs a weighted average between old image data of the previous frame stored in a buffer memory and newly input image data, and then stores the result of such weighted average in the buffer memory. In this case, depending on the weighting of the weighted average, the noise of video image may not be fully reduced, or image lag may occur in the video image after noise reduction. JP06-169920A disclose means for restrain image lag by generating processed data based on the difference between the new and old image data.

However, in case of reducing noise of a color video image using such a recursive filter, the size of the memory that stores the image data increases, and so does the computational volume required for noise reduction subsequent to an increase in the information volume of the image data. This problem is common not only to the noise reduction process using a recursive filter but also to other noise reduction processes that perform a temporal smoothing process using a non-recursive filter.

### SUMMARY

An object of the present invention is to provide a technology that reduces the computational volume for reducing noise of a color video image.

According to an aspect of the present invention, a noise reduction device to reduce noise of a video image including multiple input frame images is provided. The noise reduction device comprises: a motion detector that detects a dynamic region and a static region other than the dynamic region within the video image; and a temporal smoothing processing unit that generates temporally-smoothed frame images by applying a temporal smoothing process to the multiple input frame images, the temporal smoothing process keeping number of color component contained in each pixel, the each pixel constituting an individual frame image of the multiple input frame images and containing only a part of a plurality of color components, wherein a temporal smoothing level for a static region pixel belonging to the static region is set to be higher than the temporal smoothing level for a dynamic region pixel belonging to the dynamic region.

With this arrangement, noise reduction of video image is performed by applying a temporal smoothing process for each pixel while keeping number of color component contained in input frame images. Consequently, it is possible to apply a temporal smoothing process by performing a computation process for only part of the color components, and the computational volume in the noise reduction process may be reduced.

The noise reduction device may further comprises: a spatial smoothing filter that generates spatially-smoothed frame images by applying a spatial smoothing process to each of the multiple input frame images; and a smoothed-image mixer that mixes the temporally-smoothed frame images and the spatially-smoothed frame images. A first mixture ratio between the temporally-smoothed frame images and the spatially-smoothed frame images may be variably settable for the each pixel, and the first mixture ratio of the temporally-smoothed frame images for the static region pixel may be set to be higher than the first mixture ratio of the temporally-smoothed frame images for the dynamic region pixel.

With this arrangement, temporally-smoothed frame images which is applied the temporal smoothing process are mixed with spatially-smoothed frame images which that are generated by applying a spatial smoothing process to the input frame images. As to a pixel in the dynamic region where the temporal smoothing level is set lower, the mixture ratio of spatially-smoothed frame images is set higher, whereas the mixture ratio is set lower for a pixel in the static region where the temporal smoothing level is set higher. As a result, noise of the video image as a whole may be favorably reduced while restraining occurrence of image lag in the dynamic region.

The temporal smoothing processing unit may have: a frame storing unit that stores the temporally-smoothed frame image; and a superposing processor that generates a temporally-smoothed image of a current frame by mixing a current frame image and a previous frame temporally-smoothed image generated in the frame immediately preceding the current frame, the previous frame temporally-smoothed image being stored in the frame storing unit and being input into the temporal smoothing processing unit. The temporal smoothing level may be set by specifying a second mixture ratio between the current frame image and the previous frame temporally-smoothed image, the second mixture ratio being used for mixing in the superposing processor.

With this arrangement, temporal smoothing process is performed by mixing the current frame image and temporally-smoothed image of the previous frame generated in the frame immediately preceding the current frame and stored in the frame storing unit. Therefore, the frame storing unit is not required to store a plurality of temporally-smoothed images in the previous frames. This allows reducing of the memory capacity of the frame storing unit required for temporal smoothing process.

According to another aspect of the present invention, a noise reduction device to reduce noise of a video image including multiple input frame images is provided. The noise reduction device comprises: a motion detector that detects a dynamic region and a static region other than the dynamic region within the video image; a temporal smoothing processing unit that generates temporally-smoothed frame images by applying a temporal smoothing process to the multiple input frame images; a spatial smoothing filter that generates spatially-smoothed frame images by applying a spatial smoothing process to each of the multiple input frame images; and a smoothed image mixer that mixes the temporally-smoothed frame images and the spatially-smoothed frame images, wherein a temporal smoothing level and a mixture ratio between the temporally-smoothed frame images and the spatially-smoothed frame images are variably settable for each pixel, the each pixel constituting an individual frame image of the multiple input frame images, the temporal smoothing level for a static region pixel belonging to the static region is set to be higher than the temporal smoothing level for a dynamic region pixel belonging to the dynamic region, and the mixture ratio of the temporally-smoothed frame images for the static region pixel is set to be higher than the mixture ratio of the temporally-smoothed frame images for the dynamic region pixel.

With this arrangement, temporally-smoothed frame images which are applied the temporal smoothing process are mixed with spatially-smoothed frame images generated by applying a spatial smoothing process to the input frame images. As to a pixel in the dynamic region where the temporal smoothing level is set lower, the mixture ratio of spatially-smoothed frame images is set higher, whereas the mixture ratio is set lower for a pixel in the static region where the temporal smoothing level is set higher. As a result, noise of the video image as a whole may be favorably reduced while restraining occurrence of image lag in the dynamic region.

The present invention may be realized in various forms. For example, the present invention may be realized in the forms of a noise reduction device and a method thereof, a video camera applying the noise reduction device and the method, a control device of the video camera and a method thereof, a noise reduction device for all of the above and a method thereof, a computer program for implementing the video camera and control device and the methods thereof, recording media that record the computer program, data signals including the computer program that are embedded in the carrier waves and so on.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a block diagram showing an outline configuration of a video camera as an embodiment of the present invention;

FIG. 2 is a block diagram showing a functional configuration of the noise reduction unit as an embodiment of the present invention;

FIG. 3 is a block diagram showing a functional configuration of a noise reduction unit in a second embodiment;

FIGS. 4A and 4B are diagrams showing temporal changes in the contribution ratio of pixel values of the previously input frame image; and

FIG. 5 is a block diagram showing a functional configuration of a noise reduction unit of a third embodiment.

### DESCRIPTION OF THE PREFERRED EMBODIMENT

### A. First Embodiment

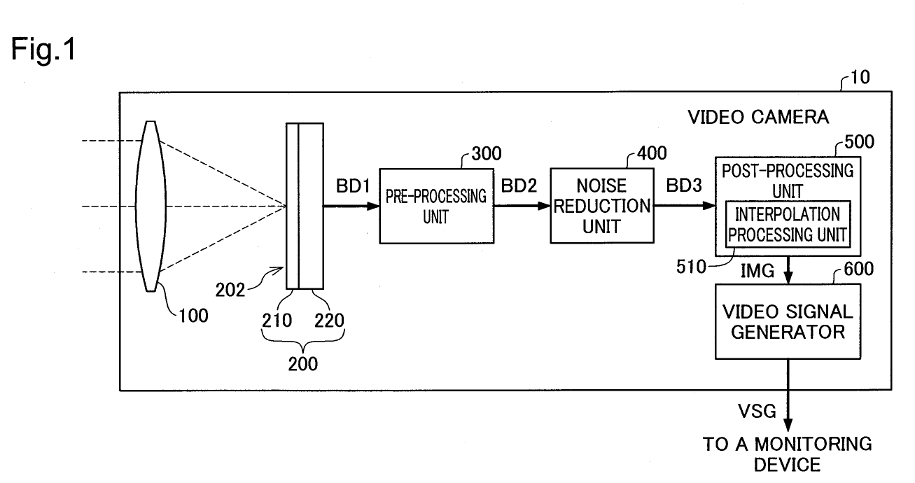

FIG. 1 is a block diagram showing an outline configuration of a video camera 10 as an embodiment of the present invention. The video camera 10 has an imaging lens 100, an image sensor 200, a pre-processing unit 300, a noise reduction unit 400, a post-processing unit 500, and a video signal generator 600.

The imaging lens 100 forms an object image on an imaging plane 202 by focusing the light from the object onto the imaging plane 202. Though the typical imaging lens 100 has a plurality of single lenses and an aperture mechanism, however the imaging lens 100 is illustrated as a single lens in FIG. 1.

The image sensor 200 has a color filter 210 and an imaging device 220 with multiple sensor elements on the side of the imaging plane 202. The color filter 210 is formed with multiple primary color filters of RGB (red-green-blue) corresponding to multiple sensor elements provided in the imaging device 220. The primary color filter for each of RGB colors provided in the color filter 210 is arranged in a checker form (called “Bayer arrangement”). The object image formed on the imaging plane 202 is separated into three colored lights of RGB by the primary color filter. Then, the separated colored lights enter into the sensor element provided in the imaging device 220.

Each sensor element of the imaging device 220 generates electric charge corresponding to intensity of light entering into the sensor element, and accumulates the generated charge. Electric signals (imaging signals) representing the charge accumulated in each sensor element are amplified by an amplifier (not illustrated). Amplified electric signals are converted into digital data by an A/D converter (not illustrated) to generate image data BD1. In the video camera 10, image data BD1 of a single frame is generated periodically.

As described above, colored lights separated by the color filter 210 in Bayer arrangement enter into each sensor element. Consequently, in the image data BD1 generated by the imaging device 220, each of pixel corresponding to an individual sensor element has only one of color values of RGB. Hereinafter such data is termed as “Bayer data.” As to the imaging device 220, a CMOS image sensor with a built-in amplifier and A/D converter, or a CCD image sensor with an attached amplifier and A/D converter (collectively called “an analog front end”) may be used.

The image data BD1 generated by the imaging device 220 is supplied to the pre-processing unit 300. The pre-processing unit 300 generates image data BD2 by applying processes such as clamping and white balance adjustment to the image data BD1 supplied from the imaging device 220. The processing by the pre-processing unit 300 is applied separately to each of color values of RGB. Therefore, the image data BD2 generated in the pre-processing unit 300 remains to be Bayer data.

The image data BD2 generated by the pre-processing unit 300 are supplied to the noise reduction unit 400. The noise reduction unit 400 generates image data BD3 by applying a noise reduction process to the image data BD2 supplied from the pre-processing unit 300. The noise reduction process is also applied separately to each of color values of RGB in the noise reduction unit 400. Therefore, the image data BD3 generated by the noise reduction unit 400 still remains to be Bayer data. The specific configuration and functions of the noise reduction unit 400 will be discussed later.

The image data BD3 generated by the noise reduction unit 400 is supplied to the post-processing unit 500. The post-processing unit 500 includes an interpolation processing unit 510 that performs interpolation. The interpolation processing unit 510 generates color values missing in each pixel of the image data BD3. More specifically, the interpolation processing unit 510 interpolates the color values of surrounding pixels and generates the color values missing in each pixel of the image data BD3. Through the interpolation process, the image data which is applied the interpolation process turn to an image data with each pixel containing 3 color values of RGB. The post-processing unit 500 generates image data IMG by applying color adjustment processes such as contrast adjustment and color correction. The color adjustment processes will not be discussed in detail since it does not affect the present invention.

The image data IMG generated by the post-processing unit 500 is supplied to a video signal generator 600. The video signal generator 600 generates video signal VSG in a given format being able to be received by a monitoring device. Supply of generated video signals VSG to the monitoring device connected to the video camera 10 results in object images to be displayed on the monitoring device.

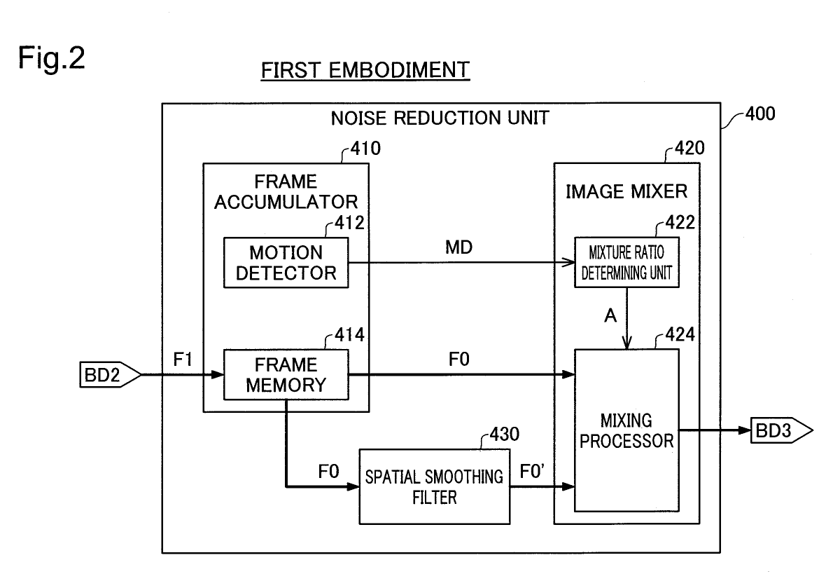

FIG. 2 is a block diagram showing a functional configuration of the noise reduction unit 400 as an embodiment of the present invention. The noise reduction unit 400 has a frame accumulator 410, an image mixer 420, and a spatial smoothing filter 430.

The frame accumulator 410 has a motion detector 412 and a frame memory 414. The frame memory 414 includes two storing areas, each of which stores an image of single frame (frame image) of image data BD2. The frame image F1 input in the noise reduction unit 400 is written alternately in the two storing areas of the frame memory 414. Then, the immediately preceding frame image F0 stored in the frame memory 414 is read out from one of the two storing areas where the frame image F1 is yet to be written.

Thus providing two storing areas to store frame images in the frame memory 414 and alternately performing reading-out and writing-in in the opposite areas allows to differentiate the number of frames per second (frame rate) of image data BD3 generated by the noise reduction unit 400 from that of image data BD2 supplied to the noise reduction unit 400. If it is not necessary to convert frame rate, the frame memory 414 may store only one frame image.

The motion detector 412 determines whether each pixel of the image data BD2 is the one belonging to an image region where the object images are in motion (dynamic region) or the one belonging to another where the object images are stationary (static region). Then, the motion detector 412 supplies to the image mixer 420 the motion detection results MD that indicate the judgment as to whether each pixel is the one belonging to a dynamic region (dynamic region pixel) or the one belonging to a static region (static region pixel).

More specifically, the motion detector 412 performs computation on each pixel to be examined (subject pixel) to calculate a difference Δ between the color values of the frame image F1 to be written in the frame memory 414 (hereinafter called “a pixel value”) and the frame image F0 to be read out from the frame memory 414. This difference A can be calculated by the following Equation (1), for example, using values p1 and p0 of the subject pixels of the two frame images F1 and F0 respectively:

Δ=|p1−p0| (1)

where the right term of Equation (1) represents an absolute value of the difference obtained by subtracting the pixel value p0 of the frame image F0 from the pixel value p1 of the frame image F1.

Since pixel values of dynamic region pixels usually vary by time according to their movements within the object image, the difference Δ of pixel values between the two frame images F1 and F0 becomes larger. On the contrary, since pixel values of static region pixels usually have limited temporal variation, the difference Δ of pixel values between the two frame images F1 and F0 becomes smaller. Therefore, the motion detector 412 compares the difference Δ calculated by Equation (1) above with the preset threshold value Δc and determines that the object pixel is a dynamic region pixel if the difference Δ is grater than the threshold value Δc (Δ>Δc). On the contrary, if the difference Δ is less or equal to the threshold value Δc (Δ≦Δc), it is determined that the object pixel is a static region pixel. Here, the threshold value Δc can be determined on the basis of a fluctuation range obtained by experimentally determining the fluctuation range of values of dynamic region pixels and static region pixels. For example, in the event the pixel value is representable by an 8-bit numeral (0-255), the threshold value Δc may be set to 150.

The frame image F0 read out from the frame memory 414 is supplied to the image mixer 420 directly, or via the spatial smoothing filter 430. This spatial smoothing filter 430 applies a spatial smoothing process to the frame image F0 to generate a frame image F0′. Spatial smoothing of the frame image F0 may be done by means of applying a spatial smoothing filter such as a Gaussian filter or a median filter to the frame image F0. This spatial smoothing reduces high-frequency components of the spatial frequency of the frame image F0, and the spatial frequency components of the smoothed frame image F0′ end up with having relatively higher low-frequency components. Therefore, this spatial smoothing filter 430 is also called “a spatial low-pass filter (spatial LPF).”

The image mixer 420 has a mixture ratio determining unit 422 and a mixing processor 424. The mixture ratio determining unit 422 determines the mixture ratio A (0≦A≦1) between the two images mixed by the mixing processor 424 based on the motion detection results MD supplied from the motion detector 412. A method of determining this mixture ratio A based on the motion detection results MD will be discussed later.

The mixing processor 424 mixes the frame image F0 directly supplied from the frame memory 414 and the frame image F0′ smoothed by the spatial smoothing filter 430 based on the mixture ratio A determined by the mixture ratio determining unit 422 on a pixel-by-pixel basis. More specifically, a pixel value q of output image data BD3 is calculated by the following Equation (2) using pixel values p and p′ of the two frame images F0 and F0′.

q=A×p+(1−A)×p′ (2)

As evident from Equation (2) above, the percentage of the pixel value p′ of the smoothed frame image F0′ gets larger relative to the pixel value q of the image data BD3 as the mixture ratio A nears zero. On the other hand, the percentage of the pixel value p of the unsmoothed frame image F0 gets larger relative to the pixel value q of the image data BD3 as the mixture ratio A nears 1. Thus, the level of smoothing in the output image data BD3 may be varied by changing the mixture ratio A.

The mixture ratio determining unit 422 determines the mixture ratio A so as to lower the smoothing level for dynamic region pixels and raise the same for static region pixels based on the motion detection results MD supplied from the motion detector 412. The mixture ratio determining unit 422 determines the mixture ratio A, for example, in the following way:
(a) For dynamic region pixels, the mixture ratio A=27/32 (approximately 0.84)
(b) For static region pixels, the mixture ratio A=16/32 (0.5)

Thus, the mixture ratio determining unit 422 sets the mixture ratio A at a higher value for dynamic region pixels. On the contrary, the mixture ratio determining unit 422 sets the mixture ratio A at a lower value for static region pixels. For this reason, the spatial smoothing level drops down in dynamic regions and climbs up in static regions within the image data BD3 output by the noise reduction unit 400. As evident from the above description, the spatial smoothing process unit composed of the spatial smoothing filter 430 and the image mixer 420 is capable of setting a spatial smoothing level for each pixel.

In general, performing spatial smoothing results in blurring of object images. For this reason, if the impact of noise on the image quality is small, it is preferable to lower the spatial smoothing level. Image in motion within an object usually tends to have no distinct noise. Therefore, deterioration of image quality caused by blurring in the dynamic region may be restrained by lowering the spatial smoothing level therein. On the contrary, stationary image within an object tends to have distinct noise. Therefore, deterioration of image quality caused by noise in the static region may be restrained by raising the spatial smoothing level therein.

Thus, according to the first embodiment, blurring of images in the dynamic region is restrained by lowering the spatial smoothing level in the dynamic region where noise is less distinct. On the contrary, noise in the static region is reduced by raising the spatial smoothing level in the static region where noise is more distinct. This reduces the impact of noise on the image as a whole while restraining deterioration of image quality caused by blurring of the parts in motion.

In the first embodiment, to set the level of spatial smoothing on a pixel-by-pixel basis, the mixture ratio A between the two frame images F0 and F0′ is determined for each pixel. The level of spatial smoothing may also be set by other means. For example, it is possible to set a smoothing parameter for the spatial smoothing filter 430 based on the motion detection results MD from the motion detector 412 on a pixel-by-pixel basis. In this case, the image mixer 420 may be omitted. However, it is preferable, as in the first embodiment, to set a spatial smoothing level by setting the mixture ratio A between the unsmoothed frame image F0 not applied the spatial smoothing and the smoothed frame image F0′ applied the spatial smoothing in the sense that configuration of the spatial smoothing filter 430 may be simpler.

### B. Second Embodiment

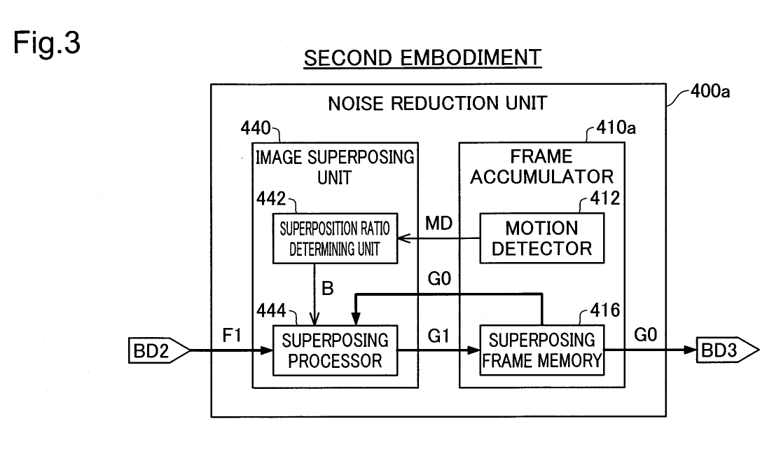

FIG. 3 is a block diagram showing a functional configuration of a noise reduction unit 400a in a second embodiment. The second embodiment is different from the first embodiment in that configuration of the noise reduction unit 400a differs from that of the noise reduction unit 400 of the first embodiment. All other aspects are the same between the two.

The noise reduction unit 400a of the second embodiment has an image superposing unit 440 and a frame accumulator 410a. This frame accumulator 410a is different from the frame accumulator 410 of the first embodiment (FIG. 2) in that the frame memory 414 is replaced by a superposing frame memory 416. All other aspects are the same as in the frame accumulator 410 of the first embodiment.

The superposing frame memory 416 is different from the frame memory 414 of the first embodiment (FIG. 2) in that the frame images written therein are modified into the frame image G1 supplied from the image superposing unit 440 and into the immediately preceding frame image G0 that is read out subsequent to the modification of frame images to be written in.

The image superposing unit 440 includes a superposition ratio determining unit 442 and a superposing processor 444. The superposition ratio determining unit 442 determines a superposition ratio B (0≦B≦1) to be used for processing in the superposing processor 444 based on the motion detection results MD supplied from the motion detector 412. The method of determining this mixture ratio B based on the motion detection results MD will be discussed later.

The superposing processor 444 mixes the frame image F1 supplied to the noise reduction unit 400a with the frame image G0 read out from the superposing frame memory 416 based on the superposition ratio B determined by the superposition ratio determining unit 442 to generate frame image G1. More specifically, a pixel value s of the frame image G1 is calculated according to the following Equation (3) from pixel values p and r of the two frame images F1 and G0:

s=(1−B)×p+B×r (3)

The generated frame image G1 is supplied to the superposing frame memory 416 and written therein. Then, the immediately preceding frame image G0 stored in the superposing frame memory 416 is read out to be mixed with the frame image F1 in the image superposing unit 440.

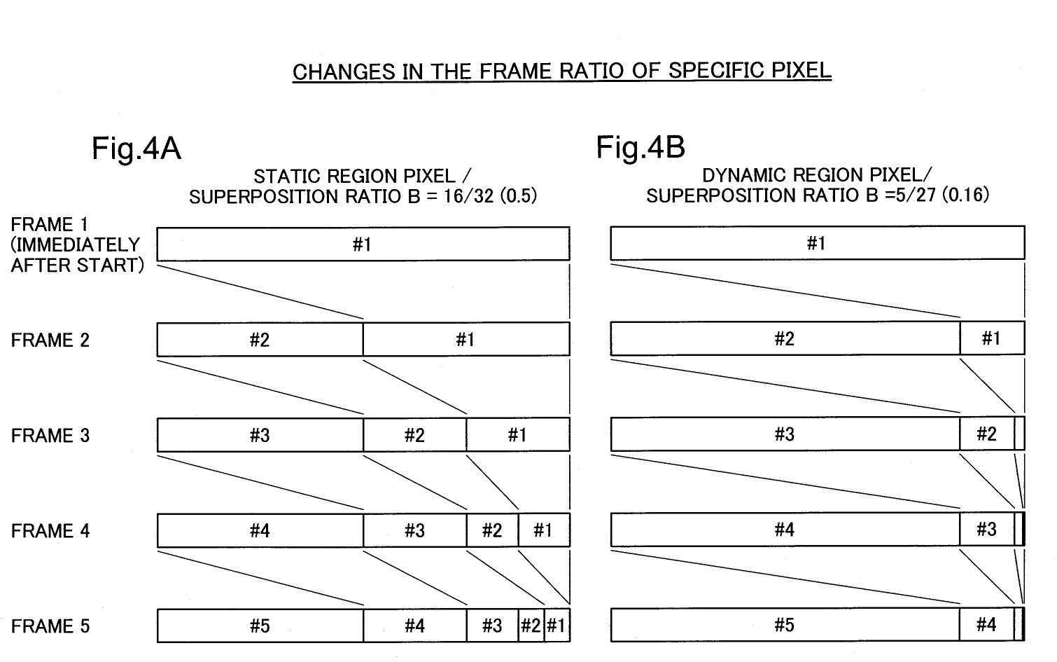

FIGS. 4A and 4B are diagrams showing temporal changes in the contribution ratio of pixel values (frame ratio) of the frame image F1 input one after another into the noise reduction unit 400a relative to the pixel values of the frame image G0 stored in the superposing frame memory 416. FIG. 4A indicates temporal changes in the frame ratio when the superposition ratio is 16/32 (=0.5), whereas FIG. 4B indicates the same when the superposition ratio is 5/32 (≈0.16).

Immediately after the start of the video camera 10 (FRAME 1), the frame image (#1) input into the noise reduction unit 400a is stored as it is in the superposing frame memory 416. Then, in FRAME 2, the frame image (#1) input in FRAME 1 is mixed with the frame image (#2) input in FRAME 2 in accordance with the superposition ratio B, and the mixed image is stored in the superposing frame image (#2). Thus, in the example of FIG. 4A, the frame ratio of the two frame images (#1, #2) are both 50%. On the other hand, in the example of FIG. 4B, the frame ratio of the frame image (#2) input in FRAME 2 is about 84% and the frame ratio of the frame image (#1) input in FRAME 1 is about 16%, which indicates that the impact of the frame image (#1) is less than that of FIG. 4A.

Similarly, in the next FRAME 3 of FIG. 4A, both of the two frame images (#1, #2) have a frame ratio of 25%, making the frame ratio of the frame image (#3) 50%. Meanwhile, in the example of FIG. 4B, the frame ratio of the frame image (#1) input in FRAME 1 drops down to about 2%.

Thus, in the example of FIG. 4A where the superposition ratio B is higher, pixel values of the previous frame image contributes for a longer period of time. For this reason, the frame image G0 stored in the superposing frame memory 416 (FIG. 3) undergoes an averaging process for a longer period of time so that the level of noise reduction in the frame image G0 output from the noise reduction unit 400a gets higher. Meanwhile, as to dynamic-region pixels, since pixel values of the previous frame image contributes for a longer period of time, image lag occurs in the dynamic region of the frame image G0 output from the noise reduction unit 400a. On the contrary, in the example of FIG. 4B where the superposition ratio B is lower, the level of noise reduction in the frame image G0 drops down due to a shorter contributing period of pixel values of the previous frame image while the occurrence of image lag in the frame image G0 may be restrained.

As shown in FIGS. 4A and 4B, pixel values are temporally-smoothed by a process that generates the superposing frame image G1 by mixing the frame image F1 input into the noise reduction unit 400a (FIG. 3) and the previous frame image G0 stored in the superposing frame memory 416 and storing the generated frame image G1 therein. Thus, the filter that performs temporal smoothing is called “a recursive filter” or “an IIR filter.” Therefore, it can be said that the superposing processor 444 in combination with the frame memory 416 makes a recursive filter. The superposition ratio B can also be considered as a parameter that specifies the level of temporal smoothing in the recursive filter.

To restrain occurrence of image lag in the dynamic region and to reduce noise in the static region in which image lag does not occurs, the superposition ratio determining unit 442 determines the superposition ratio B based on the motion detection results MD supplied from the motion detector 412. The superposition ratio determining unit 442 determines the superposition ratio, for example, in the following way:
(a) For dynamic region pixels, the mixture ratio B=5/32 (approximately 0.16)
(b) For static region pixels, the mixture ratio A=16/32 (0.5)

Thus, the superposition ratio determining unit 442 sets the superposition ratio B at a low value for dynamic region pixels. On the contrary, the superposition ratio determining unit 442 sets the superposition ratio B at a high value for static region pixels. As a result, occurrence of image lag is restrained in the dynamic region and the noise is favorably reduced in the static region within the image data BD3 output by the noise reduction unit 400a.

Since the noise is reduced by means of temporal smoothing of frame images in the second embodiment, it is preferable to the first embodiment in the sense that blurring of images caused by spatial smoothing may be restrained. Meanwhile, the first embodiment is preferable to the second embodiment in that the latter may restrain occurrence of image lag caused by temporal smoothing of frame images.

### C. Third Embodiment

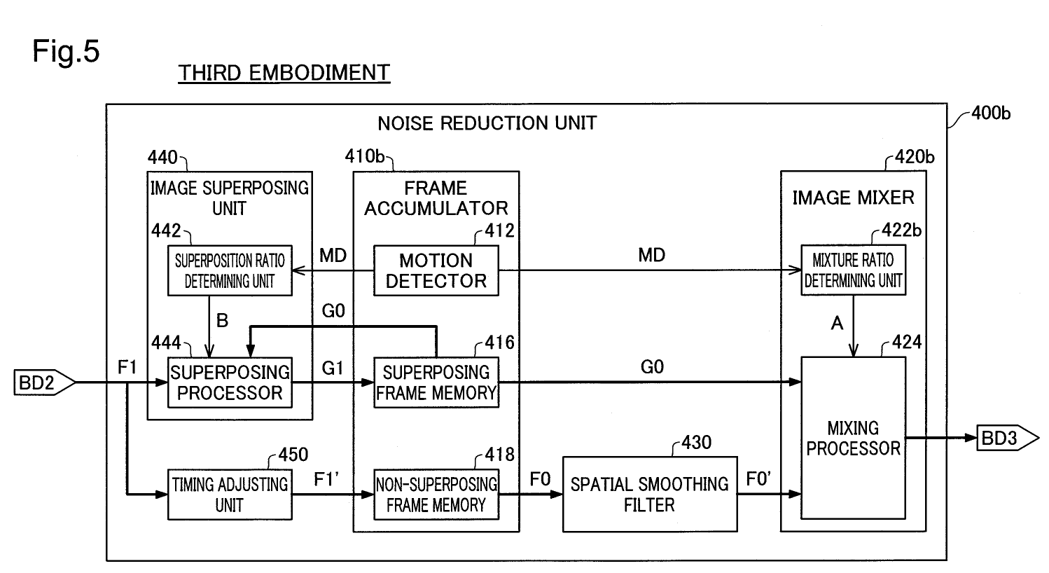

FIG. 5 is a block diagram showing a functional configuration of a noise reduction unit 400b of a third embodiment. The third embodiment is different from the second embodiment in that the configuration of the noise reduction unit 400b is different from that of the noise reduction unit 400a (FIG. 3). All other aspects are the same as in the second embodiment.

The noise reduction unit 400b of the third embodiment is different from the noise reduction unit 400a of the second embodiment shown in FIG. 3 in that the noise reduction unit 400a further includes a timing adjusting unit 450, the spatial smoothing filter 430, and an image mixer 420b; and a frame accumulator 410b further includes a non-superposing frame memory 418. All other aspects are the same as in the noise reduction unit 400a of the second embodiment.

The spatial smoothing filter 430 and the mixing processor 424 of the image mixer 420b are respectively the same as the spatial smoothing filter 430 and mixing processor 424 provided in the noise reduction unit 400 of the first embodiment. A mixture ratio determining unit 422b of the image mixer 420b is different from the mixture ratio determining unit 422 of the first embodiment in that the method of determining the mixture ratio A (to be described later) is different.

In the noise reduction unit 400b of the third embodiment, the input frame image F1 is supplied to both the image superposing unit 440 and the timing adjusting unit 450. Noise of the frame image F1 supplied to the image superposing unit 440 is reduced by undergoing a temporal smoothing process in the same manner as in the second embodiment. Then, the frame image G0 output from the superposing frame memory 416 is directly supplied to the mixing processor 424.

Meanwhile, the timing adjusting unit 450 delays the frame image F1 for the time required for the process of mixing two frame images F1 and G0 to generate a delayed frame image F1′. The delayed frame image F1′ is stored in the non-superposing frame memory 418. The previous frame image F0 stored in the non-superposing frame memory 418 is supplied to the spatial smoothing filter 430 in synchronization with the timing in which the superposing frame memory 416 outputs the frame image G0. The frame image F0′ spatially-smoothed by the spatial smoothing filter 430 is supplied to the mixing processor 424.

The mixing processor 424 mixes the temporally-smoothed frame image G0 supplied from the superposing frame memory 416 with the frame image F0′ spatially-smoothed by the spatial smoothing filter 430.

The mixture ratio determining unit 424b determines the mixture ratio A so as to reflect pixel values of the spatially-smoothed frame image F0′ at a higher percentage than those of the temporally-smoothed frame image G0 in the dynamic region where the superposition ratio B is low. Meanwhile, the mixture ratio determining unit 424b determines the mixture ratio A so as to reflect pixel values of the temporally-smoothed frame image G0 at a higher percentage than those of the spatially-smoothed frame image F0′ in the static region where the superposition ratio is low. The mixture ratio determining unit 424b specifically determines the mixture ratio in the following manner:
(a) For dynamic region pixels, the mixture ratio A=16/32 (0.5)
(b) For static region pixels, the mixture ratio A=27/32 (Approximately 0.84)

Thus, setting the superposition ratio B at a smaller value for the dynamic region makes it possible to restrain occurrence of image lag in the image data BD3 output from the noise reduction unit 400b. Also, as to the dynamic region, pixel values of the frame image F0′ which is spatially-smoothed are reflected more intensively by setting the mixture ratio A at a smaller value so that the noise of the dynamic region pixels is reduced by spatial smoothing.

Meanwhile, setting the mixture ratio A at a larger value for the static region makes pixel values of the temporally-smoothed frame image G0 reflected more intensively in the static region of the image data BD3 output from the noise reduction unit 400b. Therefore, the level of spatial smoothing is reduced in the static region to restrain the image blurring therein. By setting the superposition ratio B at a lager value for static region pixels, noise in the static region less affected by image lag is favorably reduced by temporal smoothing.

Thus, according to the third embodiment, blurring of images is restrained and the noise is favorably reduced by setting each of the mixture ratio A and superposition ratio B at a smaller value for dynamic region pixels. Meanwhile, generation of blurring caused by spatial smoothing can be restrained by setting each of the mixture ratio A and superposition B at a larger value for static region pixels. Therefore, according to the third embodiment, occurrence of image lag may be restrained, while reducing the noise of images as a whole.

In the third embodiment, the superposition ratio determining unit 442 determines the superposition ratio B based on the motion detection results MD supplied from the motion detector 412, although the superposition ratio determining unit 442 may be omitted. Even so, occurrence of image lag may be restrained by setting the mixture ratio A of the mixing processor 424 at a smaller value and reflecting the pixel values of the temporally-smoothed frame image F0′ more intensively. However, it is preferable to determine the superposition ratio B based on the motion detection results MD in the sense that occurrence of image lag may be restrained more favorably by reducing the superposition ratio B.

The third embodiment is preferable to the first and second embodiments in the sense that noise in both of the static and dynamic regions may be reduced with the noise reduction unit 400b. Meanwhile, The first and second embodiments are preferable to the third embodiment in the sense that each of their noise reduction units 400 (FIG. 2) and 400a (FIG. 3) has a simpler configuration.

### D. Modifications

The present invention is not limited to the examples and embodiments described above and may be reduced to practice in various forms without departing the scope thereof including, for example, the following modifications:

### D1. Modification 1

In each of the above embodiments, the noise reduction unit 400 (FIG. 1) is placed before the post-processing unit 500 having the interpolation processing unit 510 so that the noise reduction process is applied to Bayer data prior to the interpolation process, although the noise reduction process may be applied to the same data after the interpolation process. However, it is preferable to apply the noise reduction process to Bayer data in that applying the noise reduction process for each of color values of RGB may reduce the computational volume required for noise reduction.

### D2. Modification 2

In the second and third embodiment described above, temporal smoothing is performed using a recursive filter. However, in general, any temporal smoothing process is applicable as long as temporally-smoothed frame image is able to be generated using multiple frame images. Temporal smoothing may also be performed, for example, using a non-recursive filter. However, it is preferable to apply a temporal smoothing process using a recursive filter in terms that the capacity of the frame memory for storing frame images may be reduced.

### D3. Modification 3

In each of the above embodiments, the motion detector determines whether each pixel belongs to the dynamic or static region based on the difference of pixel values between the frame image stored in the frame memory and the frame image input into the frame memory, although other methods may be used to determine whether each pixel belongs to the dynamic or static region. It is also possible to determine whether each pixel belongs to the dynamic or static region based on the location and motion vector of moving objects by detecting them from multiple frame images.

### D4. Modification 4

In each of the above embodiments, the present invention is applied to a video camera. The present invention may also be applied to any device as long as it performs input and output operations of video image. The present invention may also be applied, for example, to recording devices and reproducing devices such as video recorders and video discs, or even video image display devices such as a television and projector.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A noise reduction device to reduce noise of a video image including multiple input frame images, the noise reduction device comprising:
a motion detector that detects a dynamic region and a static region other than the dynamic region within the video image; and
a temporal smoothing processing unit that generates temporally-smoothed frame images by applying a temporal smoothing process to the multiple input frame images, the temporal smoothing process keeping number of color component contained in each pixel, the each pixel constituting an individual frame image of the multiple input frame images and containing only a part of a plurality of color components,
wherein a temporal smoothing level for a static region pixel belonging to the static region is set to be higher than the temporal smoothing level for a dynamic region pixel belonging to the dynamic region.

2. The noise reduction device according to claim 1 further comprising:
a spatial smoothing filter that generates spatially-smoothed frame images by applying a spatial smoothing process to each of the multiple input frame images; and
a smoothed-image mixer that mixes the temporally-smoothed frame images and the spatially-smoothed frame images,
wherein a first mixture ratio between the temporally-smoothed frame images and the spatially-smoothed frame images is variably settable for the each pixel, and
the first mixture ratio of the temporally-smoothed frame images for the static region pixel is set to be higher than the first mixture ratio of the temporally-smoothed frame images for the dynamic region pixel.

3. The noise reduction device according to claim 1 wherein
the temporal smoothing processing unit has:
a frame storing unit that stores the temporally-smoothed frame image; and
a superposing processor that generates a temporally-smoothed image of a current frame by mixing a current frame image and a previous frame temporally-smoothed image generated in the frame immediately preceding the current frame, the previous frame temporally-smoothed image being stored in the frame storing unit and being input into the temporal smoothing processing unit,
wherein the temporal smoothing level is set by specifying a second mixture ratio between the current frame image and the previous frame temporally-smoothed image, the second mixture ratio being used for mixing in the superposing processor.

4. A noise reduction device to reduce noise of a video image including multiple input frame images comprising:
a motion detector that detects a dynamic region and a static region other than the dynamic region within the video image;
a temporal smoothing processing unit that generates temporally-smoothed frame images by applying a temporal smoothing process to the multiple input frame images;
a spatial smoothing filter that generates spatially-smoothed frame images by applying a spatial smoothing process to each of the multiple input frame images; and
a smoothed image mixer that mixes the temporally-smoothed frame images and the spatially-smoothed frame images,
wherein a temporal smoothing level and a mixture ratio between the temporally-smoothed frame images and the spatially-smoothed frame images are variably settable for each pixel, the each pixel constituting an individual frame image of the multiple input frame images,
the temporal smoothing level for a static region pixel belonging to the static region is set to be higher than the temporal smoothing level for a dynamic region pixel belonging to the dynamic region, and
the mixture ratio of the temporally-smoothed frame images for the static region pixel is set to be higher than the mixture ratio of the temporally-smoothed frame images for the dynamic region pixel.

5. A video camera comprising:
a video image generator that generates a video image including multiple input frame images;
a motion detector that detects a dynamic region and a static region other than the dynamic region within the video image; and
a temporal smoothing processing unit that generates temporally-smoothed frame images by applying a temporal smoothing process to the multiple input frame images, the temporal smoothing process keeping number of color component contained in each pixel, the each pixel constituting an individual frame image of the multiple input frame images and containing only a part of a plurality of color components,
wherein a temporal smoothing level for a static region pixel belonging to the static region is set to be higher than the temporal smoothing level for a dynamic region pixel belonging to the dynamic region.

6. A video camera comprising:
a video image generator that generates a video image including multiple input frame images;
a motion detector that detects a dynamic region and a static region other than the dynamic region within the video image;
a temporal smoothing processing unit that generates temporally-smoothed frame images by applying a temporal smoothing process to the multiple input frame images;
a spatial smoothing filter that generates spatially-smoothed frame images by applying a spatial smoothing process to each of the multiple input frame images; and
a smoothed image mixer that mixes the temporally-smoothed frame images and the spatially-smoothed frame images,
wherein a temporal smoothing level and a mixture ratio between the temporally-smoothed frame images and the spatially-smoothed frame images are variably settable for each pixel, the each pixel constituting an individual frame image of the multiple input frame images,
the temporal smoothing level for a static region pixel belonging to the static region is set to be higher than the temporal smoothing level for a dynamic region pixel belonging to the dynamic region, and
the mixture ratio of the temporally-smoothed frame images for the static region pixel is set to be higher than the mixture ratio of the temporally-smoothed frame images for the dynamic region pixel.

7. A noise reduction method to reduce noise of video image including multiple input frame images, the noise reduction method comprising:
detecting a dynamic region and a static region other than the dynamic region within the video image; and
generating temporally-smoothed frame images by applying a temporal smoothing process to the multiple input frame images, while keeping number of color component contained in each pixel, the each pixel constituting an individual frame image of the multiple input frame images and containing only a part of a plurality of color components,
wherein a temporal smoothing level for a static region pixel belonging to the static region is set to be higher than the temporal smoothing level for a dynamic region pixel belonging to the dynamic region.

8. A noise reduction method to reduce noise of a video image including multiple input frame images comprising:
detecting a dynamic region and a static region other than the dynamic region within the video image;
generating temporally-smoothed frame images by applying a temporal smoothing process to the multiple input frame images;
generating spatially-smoothed frame images by applying a spatial smoothing process to each of the multiple input frame images; and
mixing the temporally-smoothed frame images and the spatially-smoothed frame images,
wherein a temporal smoothing level and a mixture ratio between the temporally-smoothed frame images and the spatially-smoothed frame images are variably settable for each pixel, the each pixel constituting an individual frame image of the multiple input frame images,
the temporal smoothing level for a static region pixel belonging to the static region is set to be higher than the temporal smoothing level for a dynamic region pixel belonging to the dynamic region, and
the mixture ratio of the temporally-smoothed frame images for the static region pixel is set to be higher than the mixture ratio of the temporally-smoothed frame images for the dynamic region pixel.
